(19) United States
(12) Patent Application Publication
(10) Pub. No.: US 2016/0268698 A1
(43) Pub. Date: Sep. 15, 2016

(54) ANTENNA MODULE AND ANTENNA STRUCTURE THEREOF

(71) Applicant: Lynwave Technology Ltd., New Taipei City (TW)

(72) Inventors: San-Yuan Wu, New Taipei City (TW); Chih-Kai Liu, Hsinchu City (TW)

(21) Appl. No.: 14/838,751

(22) Filed: Aug. 28, 2015

(30) Foreign Application Priority Data
Mar. 13, 2015 (TW) 104108217

(51) Int. Cl. H01Q 21/29; H01Q 9/04

(52) U.S. Cl. CPC H01Q 21/29; H01Q 9/04

(57) ABSTRACT

An antenna module and an antenna structure thereof are provided. The antenna structure includes a baseboard, secondary antenna units, and a primary antenna unit. The baseboard has an irregular shape and is electrically connected to a ground terminal. The primary antenna unit vertically extends from an edge of the baseboard, includes a primary signal fed-in portion for receiving a primary current, and provides a primary current path with the baseboard. When the primary current flows along the primary current path, a primary radiation field is formed. The secondary antenna units are around the primary antenna unit and vertically extend from other edges of the baseboard. Each of the secondary antenna units includes a secondary signal fed-in portion for receiving a secondary current and provides a secondary current path with the baseboard. When the secondary current flows along the secondary current path, a secondary radiation field is formed.

### CROSS-REFERENCE TO RELATED APPLICATIONS

This non-provisional application claims priority under 35 U.S.C. §119(a) on Patent Application No(s). 104108217 filed in Taiwan, R.O.C. on Mar. 13, 2015, the entire contents of which are hereby incorporated by reference.

### TECHNICAL FIELD

The disclosure relates to an antenna module and an antenna structure thereof, more particularly to an antenna module and an antenna structure thereof applied in a wireless access point (WAP or AP).

### BACKGROUND

From the early twenty-first century till now, wireless access points are cheap and easily installed so they are widely and rapidly used. The wireless access point can avoid some problems caused by wired signal transmission. For example, Ethernet cables are used to perform signal transmission for electronic devices, such as personal computers or notebooks, but are hard to arranged neatly, so they are easily entangled and even easily look messy. For example, when a user attempts to install a new wired network in a building that was not constructed for wired networks, modifications to this building will have to be made in order to dispose cables of the wired network. Therefore, establishing wireless networks by wireless access points can provide users with more convenience in use.

With the popularization of mobile electronic devices, wireless access points often function as access points for electronic devices which are moving. Therefore, wireless access points may meet some problems such as a narrow reception range (known as network convergence) and incorrect direction to receive signals.

### SUMMARY

According to one or more embodiments, the disclosure provides an antenna structure. In one embodiment, the antenna structure includes a baseboard, a plurality of secondary antenna units, and a primary antenna unit. The baseboard has an irregular shape and is electrically connected to a ground terminal. Each of the secondary antenna units vertically extends from a different edge of the baseboard, includes a secondary signal fed-in portion for receiving a secondary current, and is configured to provide a secondary current path with the baseboard. When the secondary current flows along the secondary current path, a secondary radiation field is formed. The primary antenna unit vertically extends from another edge of the baseboard, includes a primary signal fed-in portion for receiving a primary current, and is configured to provide a primary current path with the baseboard. The secondary antenna units are around the primary antenna unit. When the primary current flows along the primary current path, a primary radiation field is formed. The antenna structure is configured to receive and transmit wireless signals in a direction through a directional radiation field produced by combining the primary radiation field and at least one of the secondary radiation fields together.

According to one or more embodiments, the disclosure provides an antenna module. In one embodiment, the antenna module includes an antenna structure and a plurality of switches. The antenna structure includes a baseboard, a plurality of secondary antenna units, and a primary antenna unit. The baseboard has an irregular shape and is electrically connected to a ground terminal. Each of the secondary antenna units vertically extends from a different edge of the baseboard, includes a secondary signal fed-in portion for receiving a secondary current, and is configured to provide a secondary current path with the baseboard. When the secondary current flows along the secondary current path, a secondary radiation field is formed. The primary antenna unit vertically extends from another edge of the baseboard, includes a primary signal fed-in portion for receiving a primary current, and is configured to provide a primary current path with the baseboard. The secondary antenna units are around the primary antenna unit. When the primary current flows along the primary current path, a primary radiation field is formed. Each of the switches has one terminal electrically connected to the secondary signal fed-in portion of one of the plurality of secondary antenna units, and another terminal for receiving the secondary current. Each of the plurality of switches is configured to allow the secondary current to flow into one of the secondary antenna units when turned on. The antenna module is configured to receive and transmit wireless signals in a direction through to a directional radiation field produced by combining the primary radiation field and at least one of the secondary radiation fields together when at least one of the plurality of switches is turned on.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1A is a 3D schematic view of an antenna structure according to an embodiment of the disclosure;

FIG. 1B is a schematic side view of the antenna structure in FIG. 1A according to an embodiment of the disclosure;

FIG. 2A is a 3D schematic view of an antenna structure according to another embodiment of the disclosure;

FIG. 2B is a schematic side view of the antenna structure in FIG. 2A according to an embodiment of the disclosure;

FIG. 3 is a schematic view of an antenna module according to another embodiment of the disclosure;

FIG. 4 is a schematic view of a first radiation pattern according to an embodiment of the disclosure;

FIG. 5 is a schematic view of a second radiation pattern according to an embodiment of the disclosure;

FIG. 6 is a schematic view of a third radiation pattern according to an embodiment of the disclosure;

FIG. 7 is a schematic view of a fourth radiation pattern according to an embodiment of the disclosure;

FIG. 8 is a schematic view of a fifth radiation pattern according to an embodiment of the disclosure;

FIG. 9 is a schematic view of a sixth radiation pattern according to an embodiment of the disclosure; and

FIG. 10 is a schematic view of a seventh radiation pattern according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

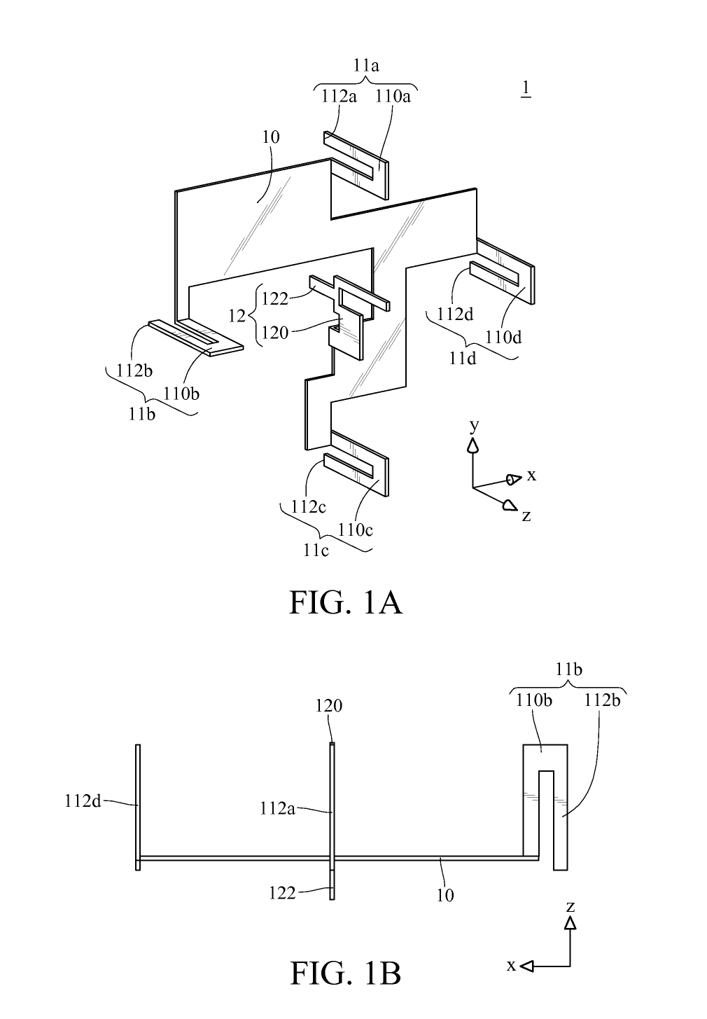

The disclosure provides an antenna structure illustrated in FIG. 1A, which is a 3D schematic view of an antenna structure 1 according to an embodiment, and FIG. 1B, which is a schematic side view of the antenna structure 1 in FIG. 1A according to an embodiment. The antenna structure 1 is applied to an antenna module and is formed by bending an integrated electric-conductive material. The electric-conductive material includes, for example but not limited to, copper and aluminum. In an exemplary embodiment, the above antenna units can be manufactured individually and then be assembled to form the antenna structure 1, but the disclosure will not be limited thereto.

The antenna structure 1 includes a baseboard 10, a plurality of secondary antenna units 11a to 11d, and a primary antenna unit 12. The baseboard 10 has, for example, a regular or irregular shape that can be designed according to a mechanism design for a system or an electronic device, which the antenna structure 1 is disposed on.

The secondary antenna units 11a to 11d vertically extend from different edges of the baseboard 10, respectively. In other words, each of the secondary antenna units 11a to 11d is sufficiently vertical to the baseboard 10 and connected to an edge of the baseboard 10. With regard to the relative positions of the secondary antenna units 11a to 11d shown in FIG. 1A, the secondary antenna units 11a to 11d form a virtual quadrilateral, and the secondary antenna units 11a to 11d are respectively at four vertices of the virtual quadrilateral. The primary antenna unit 12 vertically extends from another edge of the baseboard 10, that is, the primary antenna unit 12 is sufficiently vertical to the baseboard 10 and connected to another edge of the baseboard 10. Moreover, the primary antenna unit 12 is within such a virtual quadrilateral so that the secondary antenna units 11a to 11d are disposed around the primary antenna unit 12. The bending direction for forming the primary antenna unit 12 and the bending directions for forming the secondary antenna units 11a to 11d are the same. The antenna structure 1 can receive and transmit wireless signals with a first frequency, e.g. 5 Giga Hertz (GHz).

In order to concisely clarify the relative orientation of the antenna structure in each figure, the relative orientation of the antenna structure is indicated by a relative coordinate system with axes. For example, a three-dimensional Cartesian coordinate system with x-axis, y-axis and z-axis is shown at the lower right side of FIG. 1 for indicating the relative orientation of each component of the antenna structure 1. In the antenna structure 1, the baseboard 10 is parallel to the xy-plane formed by the x axis and the y axis, and the primary antenna unit 12 and the secondary antenna units 11a to 11d are vertically extended from the baseboard 10 along the z axis. FIG. 1B is a side-view obtained by looking to the xz-plane along the y axis. In view of FIG. 1B, all the primary antenna unit 12 and the secondary antenna units 11a and 11d are on the yz-plane. The following figures can be deduced by analogy and thus, will not be repeated later.

The baseboard 10 is considered as a ground plate when electrically connected to an external ground terminal. The primary antenna unit 12 includes a primary signal fed-in portion 122 for receiving a primary current. The primary antenna unit 12 and the baseboard 10 work together to provide a primary current path to the antenna structure 1. When the primary current is fed into the antenna structure 1 from the primary signal fed-in portion 122 and flows along the primary current path, a primary radiation field forms on the antenna structure 1 for the antenna structure 1 to receive or transmit wireless signals with the first frequency. Each of the secondary antenna units 11a to 11d includes a secondary signal fed-in portion, e.g. relative one of the secondary signal fed-in portions 112a to 112d, for receiving a secondary current. Each of the secondary antenna units 11a to 11d and the baseboard 10 form a secondary current path for the antenna structure 1. When the secondary currents are fed in the antenna structure 1 from the secondary signal fed-in portions 112a to 112d respectively and flow along their corresponding secondary current paths, secondary radiation fields form on the antenna structure 1.

When the primary current and at least one secondary current are fed in the antenna structure 1 at the same time and respectively flow along the primary current path and the corresponding secondary current path, the primary radiation field and the secondary radiation field will form on the antenna structure 1 and the secondary radiation field will affect the primary radiation field. Therefore, the radiation pattern of the primary radiation field will change, and the primary radiation field and the secondary radiation field combine to form a directional radiation field. This directional radiation field indicates a certain orientation, that is, the energy of the directional radiation field gathers together along the certain orientation. When receiving or transmitting wireless signals through the directional radiation field, the antenna structure 1 may receive or transmit these signals traveling along a certain orientation more efficiently and the received/transmitted wireless signals may have better quality.

The shape of the primary antenna unit 12 and the shape of the secondary antenna unit are different, thereby affecting the impedance matching for the primary antenna unit 12 and the secondary antenna unit. Therefore, when the primary current and the secondary current flow along their corresponding current path, the radiation pattern and frequency of the primary antenna unit 12 are different from the radiation pattern and frequency of the secondary antenna unit in response to the different impedances.

As shown in FIG. 1A, the primary antenna unit 12 further includes a connection portion 120 connected to the baseboard 10. The connection portion 120 has a first serpentine shape. The primary signal fed-in portion 122 extends along a reverse z axis from an edge of the connection portion 120 toward the xy-plane where the baseboard 10 is. In other words, the primary signal fed-in portion 122 is connected to an edge of the connection portion 120 and sufficiently vertical to the baseboard 10. As shown in FIG. 1B, the primary signal fed-in portion 122 crosses the xy-plane, i.e. the baseboard 10. The secondary antenna units 11a to 11d are U-shaped component 110a to 110d. Each of the U-shaped components 110a to 110d has a branch connected to the baseboard 10, and another branch considered as one of the secondary signal fed-in portions 112a to 112d. Each of the secondary signal fed-in portions 112a to 112d extends toward the xy-plane where the baseboard 10 is. Each of the secondary signal fed-in portions 112a to 112d is sufficiently vertical to and crosses the baseboard 10.

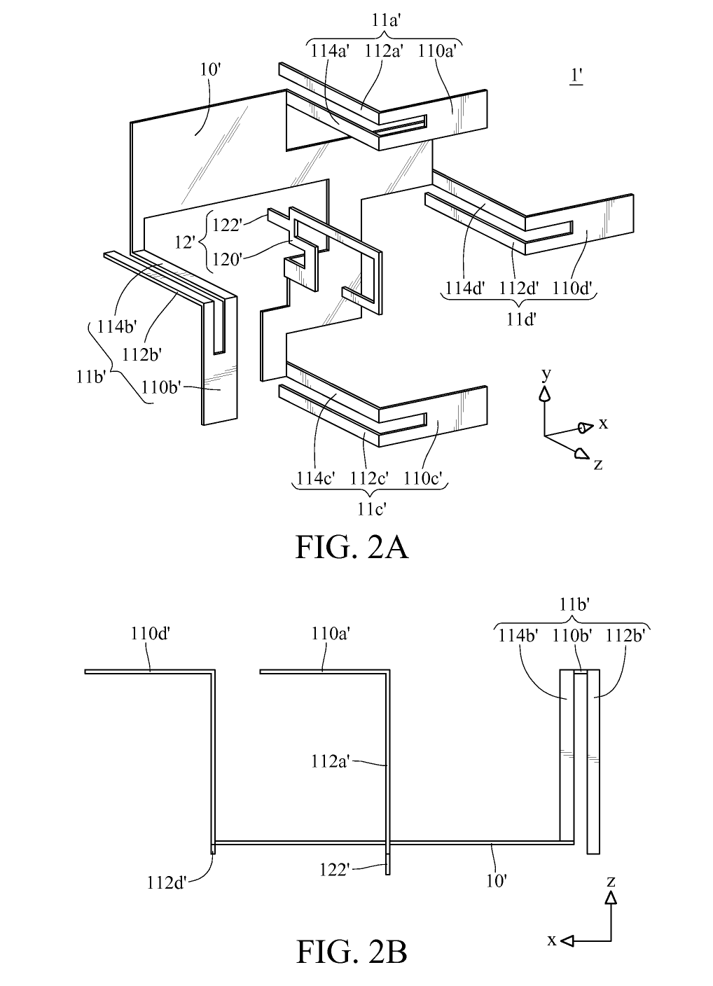

Please refer to FIG. 2A, which is a 3D schematic view of an antenna structure 1′ according to another embodiment, and FIG. 2B, which is a schematic side view of the antenna structure 1′ in FIG. 2A according to an embodiment. The antenna structure 1′ includes a primary antenna unit 12′ and a plurality of secondary antenna units 11a′ to 11d′. The shape of the primary antenna unit 12′ is different from that of the primary antenna unit 12 in FIG. 1A and FIG. 1B, and the shapes of the secondary antenna units 11a′ to 11d′ are different from those of the secondary antenna units 11a to 11d in FIG. 1A and FIG. Therefore, the antenna structure 1′ can receive and transmit wireless signals with a second frequency, e.g. 2.4 GHz. The primary antenna unit 12′ includes a connection portion 120′ having a second serpentine shape.

Each of the secondary antenna units 11a′ to 11d′ includes one of U-shaped components 110a′ to 110d′, one of secondary signal fed-in portions 112a′ to 112d′, and one of extension portions 114a′ to 114d′. The U-shaped components 110a′ to 110d′ are sufficiently parallel to the baseboard 10′. The extension portion vertically extends from a branch of the corresponding U-shaped component toward the baseboard 10′ and is sufficiently vertical to the baseboard 10′ and the corresponding U-shaped component and connected to the baseboard 10′. The secondary signal fed-in portion vertically extends from another branch of the corresponding U-shaped component toward the baseboard 10′ along a second direction, i.e. the z axis. The secondary signal fed-in portions 112a′ to 112d′, as shown in FIG. 2B, cross the baseboard 10′ and are sufficiently vertical to the U-shaped component 110a to 110d′ respectively.

In the foregoing embodiments, the disclosure designs the shape of each antenna unit to make the antenna structure have a desired impedance and a desired radiation pattern for receiving or transmitting wireless signals having a desired frequency. In these or some embodiments, the disclosure also makes the antenna module have a desired radiation pattern by controlling the secondary current fed in the antenna structure. The following embodiments will be illustrated based on the antenna module including the antenna structure 1′.

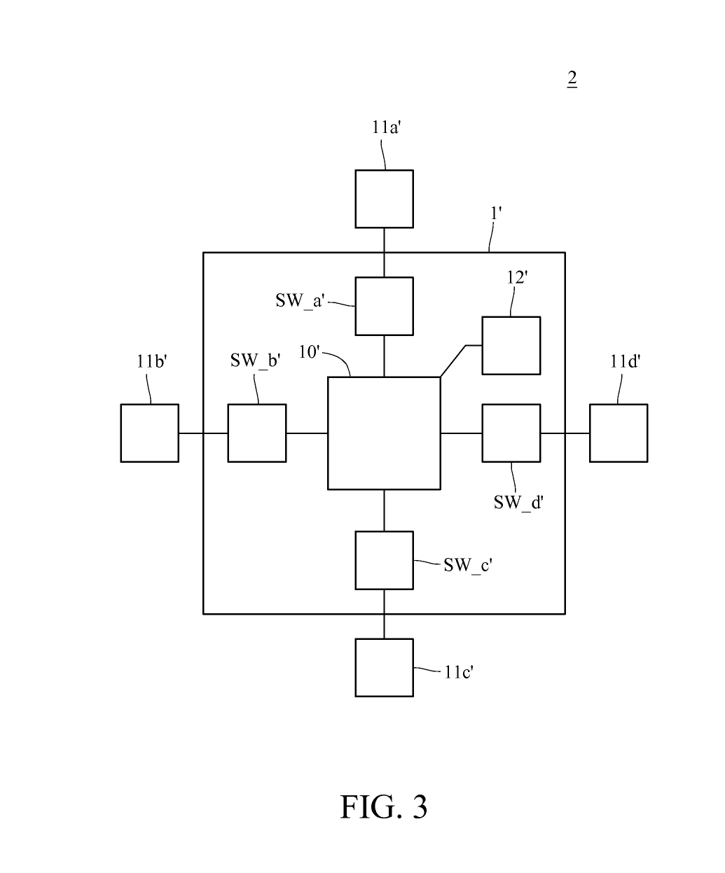

Please refer to FIG. 3, which is a schematic view of an antenna module 2 according to another embodiment of the disclosure. The antenna module 2 includes the antenna structure 1′ in FIG. 2A and FIG. 2B and a plurality of switches. Each of the switches corresponds to one of the secondary antenna units 11a′ to 11d′. For the equivalent function of each element in the antenna structure 1′, The baseboard 10′ is electrically connected to the primary antenna unit 12′ and the switches SW_a′ to SW_d′, and each of the switches SW_a′ to SW_d′ is electrically connected to one of the secondary antenna units 11a′ to 11d′.

Each of the switches SW_a′ to SW_d′ has two terminals. One of the two terminals of each of the switches SW_a′ to SW_d′ is electrically connected to one terminal of one of the extension portions 114a′ to 114d′, which is close to the baseboard 10′ while the other terminal of each of the switches SW_a′ to SW_d′ is electrically connected to another terminal of one of the extension portions 114a′ to 114d′, which is far from the baseboard 10′. The switches SW_a′ to SW_d′ are selectively turned on to allow the secondary current flowing along the current path formed by the corresponding secondary antenna unit and the baseboard 10′. For example, when the switch SW_a′ is turned on, a secondary current flows along the current path formed by the secondary antenna unit 11a′ and the baseboard 10′ and a secondary radiation field then forms on the secondary antenna unit 11a′. The relationships between the switch SW_b′ and the secondary antenna unit 11b′, between the switch SW_c′ and the secondary antenna unit 11c′ and between the switch SW_d′ and the secondary antenna unit 11d′ can be deduced by analogy and thus, will not be repeated hereinafter.

The operations of the switches SW_a′ to SW_d′ are independent to each other. Therefore, the operations of the secondary antenna units 11a′ to 11d′ are independent to each other to make one or more secondary radiation fields formed according to the operations of the switches SW_a′ to SW_d′. In other words, the number of turned-on ones of the switches SW_a′ to SW_d′ can be set for controlling the number of secondary radiation fields formed and the orientation thereof and even deciding the directional radiation field. For example, the switches SW_a′ to SW_d′ are, but not limited to, switching diodes or metal-oxide-semiconductor field-effect transistors (MOSFET).

In an exemplary embodiment based on the antenna module 2 including the antenna structure 1′, the radiation pattern produced by the antenna module 2 is varied according to the number of turned-on switches and the orientations of the turned-on switches. The secondary antenna units 11a′ to 11d′ are respectively considered as the first, second, third and fourth secondary antenna units 11a′ to 11d′ in order, and the switches SW_a′ to SW_d′ respectively corresponding to the first, second, third and fourth secondary antenna units 11a′ to 11d′ are respectively considered as the first, second, third and fourth sub switches SW_a′ to SW_d′ in order. The radiation pattern produced by the antenna structure 1′ is 3D irregular spherical. To concisely clarify the disclosure, the following various embodiments of radiation pattern are 2D radiation patterns obtained by observation along a line of sight that is sufficiently vertical to the baseboard 10′. Such a line of sight is the foregoing second direction.

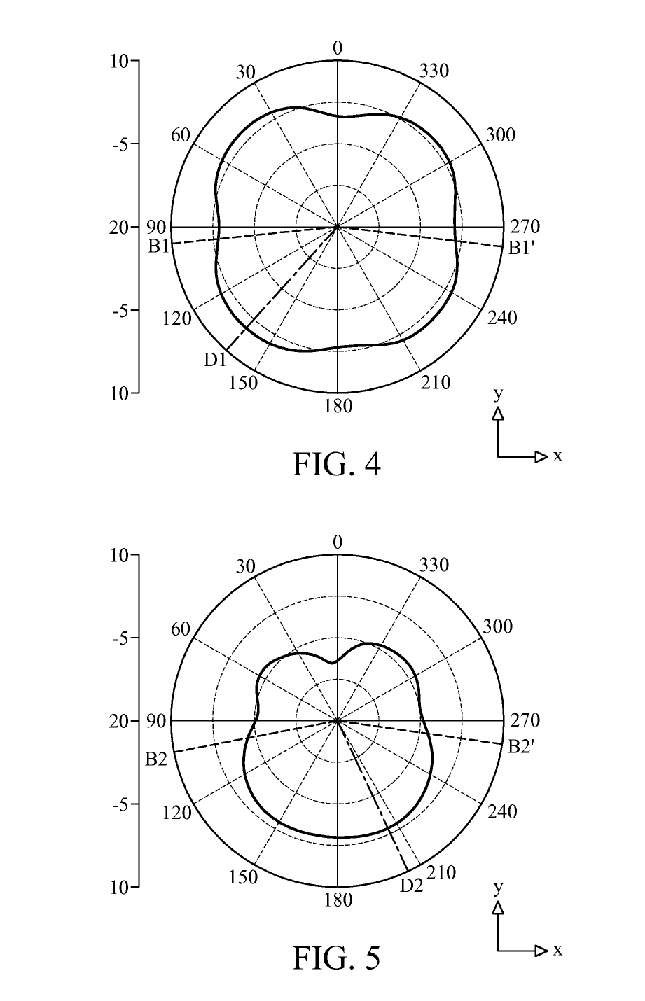

Please refer to FIG. 4, which is a schematic view of a first radiation pattern according to an embodiment. FIG. 4 is drawn with concentric circles formed by dashed lines, and the center point of these concentric circles is the center of the antenna structure 1′. Each concentric circle of a different radius has a circumference representing a radiant intensity having a different decibel (dB). The outermost concentric circle denotes 10 dB, and the center of these concentric circles denotes −20 dB. The outermost concentric circle is marked with azimuths of 0, 30, 60, 90, 120, 150, 180, 210, 240, 270, 300 and 330 degrees anticlockwise. The azimuth of 0 degree corresponds to the orientation of the first secondary antenna unit 11a′, the azimuth of 90 degrees corresponds to the orientation of the second secondary antenna unit 11b′, the azimuth of 180 degrees corresponds to the orientation of the third secondary antenna unit 11c′, and the azimuth of 270 degrees corresponds to the orientation of the fourth secondary antenna unit 11d′. The axis indicating both the angles of 0 degree and 180 degrees corresponds to the y axis, and the axis indicating both the angles of 90 degrees and 270 degrees corresponds to the x axis.

When the first, second, third and fourth switches SW_a′ to SW_d′ are turned off, the primary current flows along the primary current path and no secondary current is fed in any of the secondary antenna units 11a′, 11b′, 11c′ and 11d′ of the antenna structure 1′. Accordingly, the primary radiation field of the antenna structure 1′ has the first radiation pattern, as shown in FIG. 4, and the antenna module 2 can receive and transmit signals in every orientation of the first radiation pattern by the primary radiation field. In view of the first radiation pattern, the energy of the primary radiation field gathers at the orientation marked by the auxiliary line D1 most. Therefore, the antenna module 2 may receive and transmit wireless signals in a range formed by the auxiliary lines B1, B1′ and D1 more efficiently than other orientations.

Please refer to FIG. 5, which is a schematic view of a second radiation pattern according to an embodiment. When the primary current is fed in the primary signal fed-in portion 122′ and flows along the primary current path, the primary radiation field is formed. When the first switch SW_a′ is turned on, the secondary current flows along the secondary current path formed by the first secondary antenna unit 11a′ and the baseboard 10′ at the orientation of the azimuth of 0 degree and a secondary radiation pattern is then formed. The primary radiation pattern and the secondary radiation pattern overlap and repel each other to form a second radiation pattern as shown in FIG. 5. In addition, the energy formed by the antenna structure 1′ gathers together at the orientation of the auxiliary line D2 in the second radiation pattern most. Therefore, the antenna module 2 may more efficiently receive and transmit wireless signals in the range formed by the auxiliary lines B2, B2′ and D2 than other orientations.

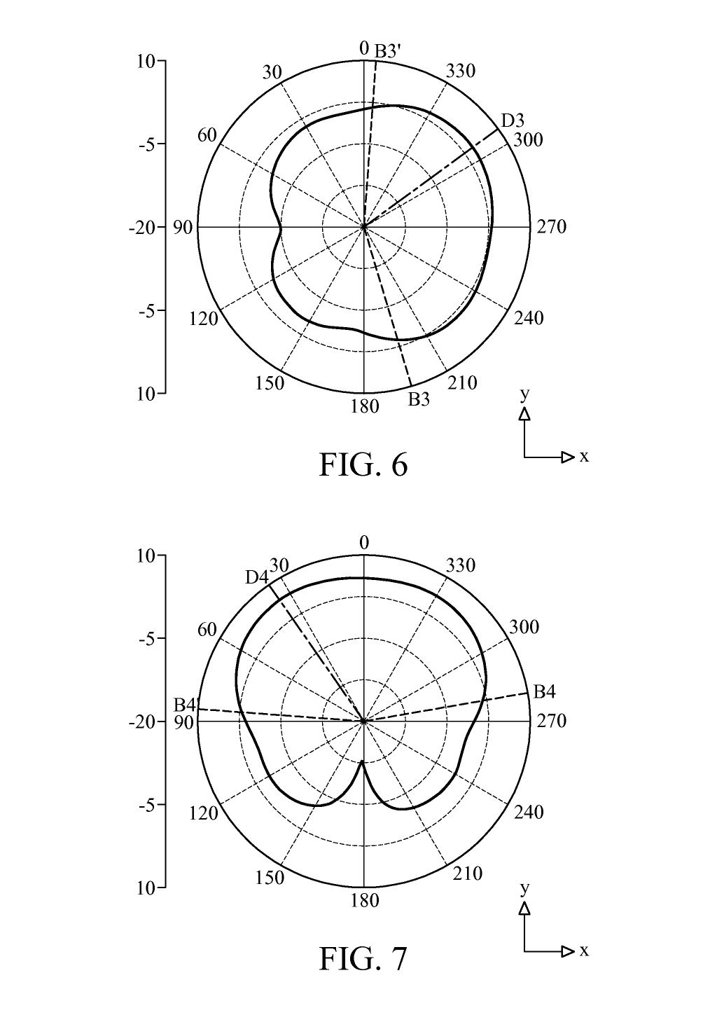

Please refer to FIG. 6, which is a schematic view of a third radiation pattern according to an embodiment of the disclosure. The primary current is fed into the antenna structure 1′ from the primary signal fed-in portion and then causes a primary radiation field. Also, the second switch SW_b′ corresponding to the angle of 90 degrees is turned on, and then when the secondary current is fed in and flows along the secondary current path formed by the second secondary antenna unit 11b′ and the baseboard 10′, a secondary radiation field is formed correspondingly. The primary radiation field and the secondary radiation field overlap and repel each other and then form the third radiation pattern as shown in FIG. 6. Thus, the antenna module 2 can receive and transmit signals at any orientation in the third radiation pattern. Moreover, the energy caused by the antenna structure 1′ focuses on the orientation of the auxiliary line D3 in the third radiation pattern the most. Therefore, the antenna module 2 may more efficiently receive and transmit wireless signals in the range formed by the auxiliary lines B3, B3′ and D3 than other orientations. Because of the various secondary radiation fields, the angle indicated by the auxiliary line D3 is different from the angles indicated by the auxiliary lines D1 and D2, as shown in figures.

Please refer to FIG. 7, which is a schematic view of a fourth radiation pattern according to an embodiment of the disclosure. Different from the embodiment of FIG. 6, only the third switch SW_c′ corresponding to the angle of 180 degrees in the embodiment of FIG. 7 is turned on so that a secondary radiation field is formed. The primary radiation field and the secondary radiation field overlap and repel each other to form the fourth radiation pattern as shown in FIG. 7. Therefore, the antenna module 2 can receive and transmit signals at all orientations in the fourth radiation pattern. Additionally, the energy of the antenna structure 1′ focuses on the orientation of the auxiliary line D4 in the fourth radiation pattern most. Therefore, the antenna module 2 may more efficiently receive and transmit wireless signals in the range formed by the auxiliary lines B4, B4′ and D4.

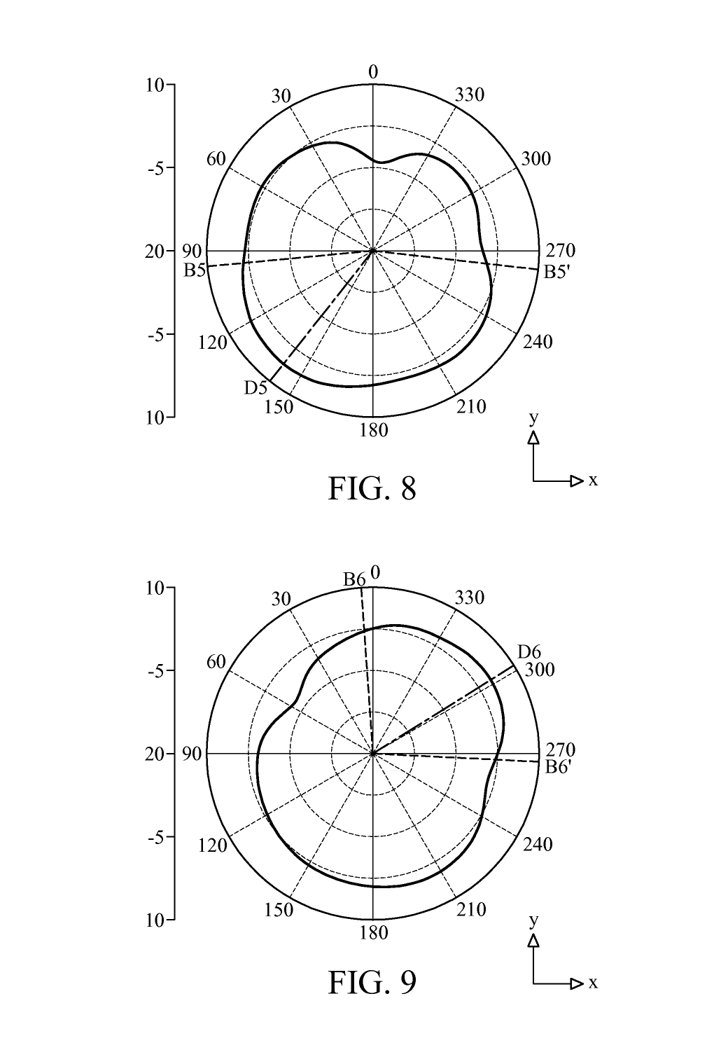

Please refer to FIG. 8, which is a schematic view of a fifth radiation pattern according to an embodiment of the disclosure. In this embodiment, only the fourth switch SW_d′ corresponding to the angle of 270 degrees is turned on, and then a secondary radiation field is correspondingly formed. The primary radiation field and the secondary radiation field overlap and repel each other and then form the fifth radiation pattern as shown in FIG. 8. Accordingly, the antenna module 2 can receive and transmit signals at all orientations in the fifth radiation pattern. Additionally, the energy formed by the antenna structure 1′ most focuses at the orientation of the auxiliary line D5 in the fifth radiation pattern. Therefore, the antenna module 2 may receive and transmit wireless signals in the range formed by the auxiliary lines B5, B5′ and D5 more efficiently than other orientations.

In view of the foregoing embodiments of radiation pattern in FIG. 4 to FIG. 8, the antenna module in the disclosure selectively turns on a single one of the switches to allow the secondary current to flow into the secondary current path of the secondary antenna unit corresponding to the turned-on switch, to form the directional radiation field having the radiation pattern as shown in corresponding one of FIG. 4 to FIG. 8, and the orientations of these radiation patterns are different from each other. Therefore, in addition to receive and transmit wireless signals at every orientation, the antenna module 2 may receive and transmit wireless signals in the range formed by the auxiliary lines B1, B1′ and D1, the auxiliary lines B2, B2′ and D2, the auxiliary lines B3, B3′ and D3, the auxiliary lines B4, B4′ and D4, or the auxiliary lines B5, B5′ and D5 more efficiently by the switching of the foregoing radiation patterns.

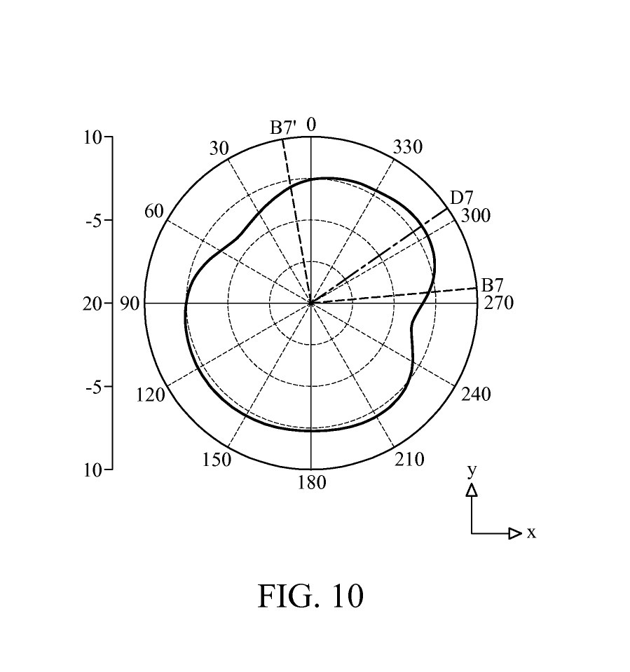

In another embodiment, the antenna module 2 turns on more than one of the switches to form a directional radiation field having a certain radiation pattern, for example, a sixth radiation pattern as shown in FIG. 9 and a seventh radiation pattern as shown in FIG. 10. The sixth radiation pattern in FIG. 9 and the seventh radiation pattern in FIG. 10 are different from the radiation patterns in FIG. 4 to FIG. 8. The sixth radiation pattern in FIG. 9 occurs when the switches SW_a′ and SW_b′ are turned on. The antenna module 2 may more efficiently receive and transmit wireless signals in the range formed by the auxiliary lines B6, B6′ and D6. The seventh radiation pattern in FIG. 10 occurs when the switches SW_a′, SW_b′ and SW_c′ are turned on. The antenna module 2 may more efficiently receive and transmit wireless signals in the range formed by the auxiliary lines B7, B7′ and D7. The details about the embodiments in FIG. 9 and FIG. 10 can be deduced by analogy according to the embodiments in FIG. 4 to FIG. 8 and thus, will not be repeated hereinafter.

Accordingly, the disclosure provides an antenna module and an antenna structure thereof. The antenna structure includes the primary antenna unit for producing a primary radiation field according to the fed-in primary signal, and the secondary antenna units for producing one or more secondary radiation fields according to one or more fed-in secondary signals. The antenna module includes the foregoing antenna structure and the switches for selectively being turned on, so that the one ore more secondary currents are fed into one or more of the secondary antenna units to form one or more secondary radiation fields. By the switching on/off of the switches, the antenna module selectively produces one or more secondary radiation fields having different secondary radiation patterns to form a directional radiation pattern indicating a desired direction. Therefore, the direction of data transmission is changed according to a user's position. The disclosure may have a higher quality of signal communication and a higher utility when applied to a smart antenna.

What is claimed is:

1. An antenna structure, comprising:
a baseboard having an irregular shape and being electrically connected to a ground terminal;
a plurality of secondary antenna units each vertically extending from a different edge of the baseboard, comprising a secondary signal fed-in portion for receiving a secondary current, and being configured to provide a secondary current path with the baseboard, and a secondary radiation field being formed when the secondary current flows along the secondary current path; and
a primary antenna unit vertically extending from another edge of the baseboard, comprising a primary signal fed-in portion for receiving a primary current, and being configured to provide a primary current path with the baseboard, the plurality of secondary antenna units being around the primary antenna unit, and a primary radiation field being formed when the primary current flows along the primary current path;
wherein the antenna structure is configured to receive and transmit wireless signals in a direction through a directional radiation field produced by combining the primary radiation field and at least one of the secondary radiation fields together.

2. The antenna structure according to claim 1, wherein the primary antenna unit further comprises a connection portion that has a serpentine shape and is connected to the baseboard, and the primary signal fed-in portion extends from an edge of the connection portion toward the baseboard and crosses the baseboard.

3. The antenna structure according to claim 1, wherein each of the plurality of secondary antenna units is a U-shaped component, a branch of the U-shaped component is connected to the baseboard, and another branch of the U-shaped component is the secondary signal fed-in portion and extends toward and vertically crosses the baseboard.

4. The antenna structure according to claim 1, wherein each of the plurality of secondary antenna units further comprises an extension portion and a U-shaped component, the U-shaped component is parallel to the baseboard, the extension portion vertically extends from a branch of the U-shaped component that is vertically connected to the baseboard and is vertical to the U-shaped component, and the secondary signal fed-in portion vertically extends from another branch of the U-shaped component, crosses the baseboard, and is vertical to the U-shaped component.

5. The antenna structure according to claim 1, wherein the antenna structure is formed integrally, each of the plurality of secondary antenna units is at one of vertices of a virtual quadrilateral, and the primary antenna unit is inside the virtual quadrilateral.

6. An antenna module, comprising:
an antenna structure, comprising:
a baseboard having an irregular shape and being electrically connected to a ground terminal;
a plurality of secondary antenna units each vertically extending from a different edge of the baseboard, comprising a secondary signal fed-in portion for receiving a secondary current, and being configured to provide a secondary current path with the baseboard, and a secondary radiation field being formed when the secondary current flows along the secondary current path; and
a primary antenna unit vertically extending from another edge of the baseboard, comprising a primary signal fed-in portion for receiving a primary current, and being configured to provide a primary current path with the baseboard, the plurality of secondary antenna units being around the primary antenna unit, and a primary radiation field being formed when the primary current flows along the primary current path; and
a plurality of switches each having one terminal electrically connected to the secondary signal fed-in portion of one of the plurality of secondary antenna units, and another terminal for receiving the secondary current, and each of the plurality of switches being configured to allow the secondary current to flow into one of the plurality of secondary antenna units when turned on;
wherein the antenna module is configured to receive and transmit wireless signals in a direction through to a directional radiation field produced by combining the primary radiation field and at least one of the secondary radiation fields together when at least one of the plurality of switches is turned on.

7. The antenna module according to claim 6, wherein the primary antenna unit further comprises a connection portion that has a serpentine shape and is connected to the baseboard, and the primary signal fed-in portion extends from an edge of the connection portion toward the baseboard and crosses the baseboard.

8. The antenna module according to claim 6, wherein each of the plurality of secondary antenna units is a U-shaped component, a branch of the U-shaped component is connected to the baseboard, and another branch of the U-shaped component is the secondary signal fed-in portion and extends toward and vertically crosses the baseboard.

9. The antenna module according to claim 6, wherein each of the plurality of secondary antenna units further comprises an extension portion and a U-shaped component, the U-shaped component is parallel to the baseboard, the extension portion vertically extends from a branch of the U-shaped component that is vertically connected to the baseboard and is vertical to the U-shaped component, and the secondary signal fed-in portion vertically extends from another branch of the U-shaped component, crosses the baseboard, and is vertical to the U-shaped component.

10. The antenna module according to claim 6, wherein the antenna structure is formed integrally, each of the plurality of secondary antenna units is at one of vertices of a virtual quadrilateral, and the primary antenna unit is inside the virtual quadrilateral.
